(19) United States
(12) Patent Application Publication
(10) Pub. No.: US 2005/0289451 A1
(43) Pub. Date: Dec. 29, 2005

(54) Electronic discussion system and reading message method for exchanging information among users

(76) Inventor: Kazuyuki Ichikawa, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/157,853

(22) Filed: Jun. 22, 2005

(30) Foreign Application Priority Data
Jun. 25, 2004 (JP) 2004-188056

(51) Int. Cl. G06F 17/00

(52) U.S. Cl. 715/507

(57) ABSTRACT

An electronic discussion system that reliably provides an answer to a message is provided. A message management unit accepts a message specifying at least an answerer and an answer to the message from a plurality of networked terminals. The message management unit has a message management table. The message management table is used to manage the accepted message and the answer to the message in a browsable manner. The message management unit further accepts a signal, which indicates whether the answerer has an intention to answer the answerer-specifying message, via a terminal operated by the answerer. The accepted signal is registered in the message management table.

### INCORPORATION BY REFERENCE

The present application claims priority from Japanese application JP2004-188056 filed on Jun. 25, 2004, the content of which is hereby incorporated by reference into this application.

### BACKGROUND OF THE INVENTION

The present invention relates to an electronic discussion system, and more particularly to an electronic discussion technology that allows users to register and browse messages from a plurality of networked terminals.

Conventionally, an electronic bulletin board system, which comprises means for specifying an attribute for a question subscribed to a bulletin board, is proposed. This system references an expert database, where an attribute is associated with an expert who should answer the question, and sends a mail prompting the expert, who is associated with the attribute specified in the question, to send an answer.

Such a system allows an expert to notice a question without frequently referencing the electronic discussion room and prompts the expert to answer. Such a technology is disclosed in JP-A-2002-352063.

### SUMMARY OF THE INVENTION

However, though a notification is sent to a person (an expert) registered in the expert database in the system according to the conventional technology described above, a user who sent a question has no way to know whether the expert has received the question or whether the expert intends to answer the question. Therefore, the user has no way to know whether he/she can receive an answer.

In addition, even if the expert has an intention to answer the question, the deadline of the answer is not specified. Thus, the expert sometimes fails to answer the question.

In view of those problems, it is an object of the present invention to increase a possibility of receiving an answer (or a response) to a message.

To solve the above problems, the present invention employs the following means.

An electronic discussion system comprises a message management unit that accepts a message, which is an answerer-specifying message specifying at least an answerer, and an answer to the message from a plurality of networked terminals; and a message management table in which the accepted message and the answer to the message are managed in a browsable manner, wherein the message management unit further accepts a signal, which indicates whether the answerer has an intention to answer the answerer-specifying message, via a terminal operated by the answerer and registers the accepted signal in the message management table.

The electronic discussion system according to the present invention, which has the function described above, provides the user with an answer in an electronic discussion.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the configuration of an electronic discussion system.

FIG. 2 is a diagram showing the processing of a message management unit.

FIG. 3 is a diagram showing the detail of a message management table.

FIG. 4A is a diagram showing an example of a display view displayed on a user terminal.

FIG. 4B is a diagram showing an example of a display view displayed on a user terminal.

FIG. 5 is a diagram showing an example of a message display view displayed on a user terminal.

FIG. 6 is a diagram showing a second embodiment of the present invention.

FIG. 7 is a diagram showing the processing of a schedule management unit.

FIG. 8 is a diagram showing the detail of a schedule management table.

FIG. 9 is a diagram showing the processing of a message management unit.

FIG. 10 is a diagram showing the contents of the schedule management table in which a message is registered.

FIG. 11 is a diagram showing a third embodiment of the present invention.

FIG. 12 is a diagram showing the processing of a mail delivery unit.

### DESCRIPTION OF THE EMBODIMENTS

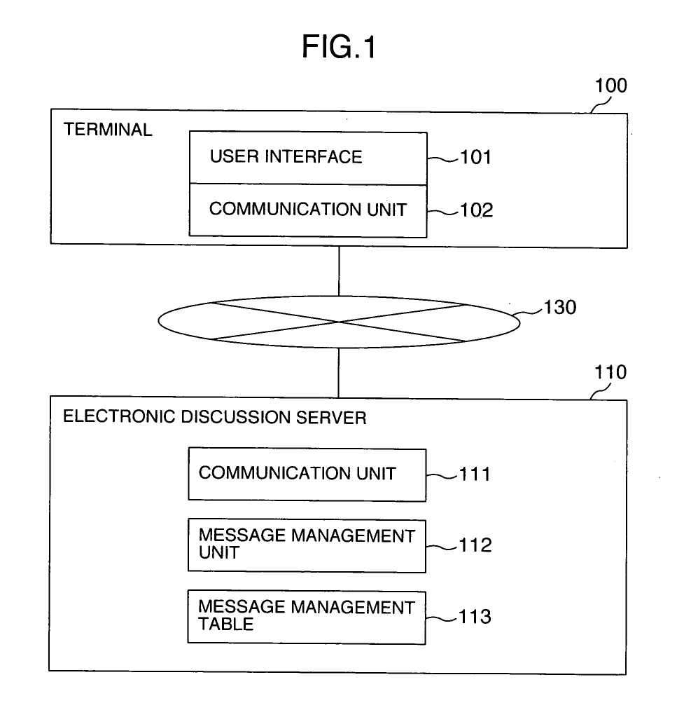

Embodiments will be described below with reference to the drawings. FIG. 1 is a diagram showing the general configuration of an electronic discussion system in a first embodiment. Referring to the figure, numeral 100 denotes a user terminal used by a user in this system, numeral 110 denotes an electronic discussion server that provides an electronic discussion system, and numeral 130 denotes a network that connects the electronic discussion server 110 and the user terminal. Numeral 101 denotes a user interface, and numeral 102 denotes a communication unit used for communication with the electronic discussion server.

Numeral 111 denotes a communication unit used for communication with the user terminal, and numeral 112 denotes a message management unit. As will be described later, the message management unit 112 accepts information such as a message specifying an answerer, who will answer a question, from the user terminal and an answer to the message. Numeral 113 denotes a message management table in which the accepted information is stored in such a way the information can be browsed from the user terminal.

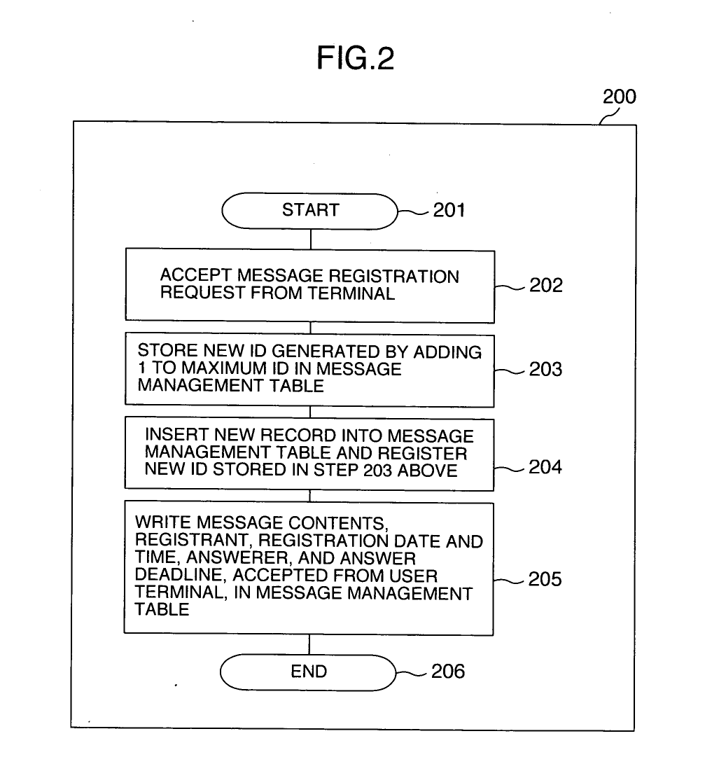

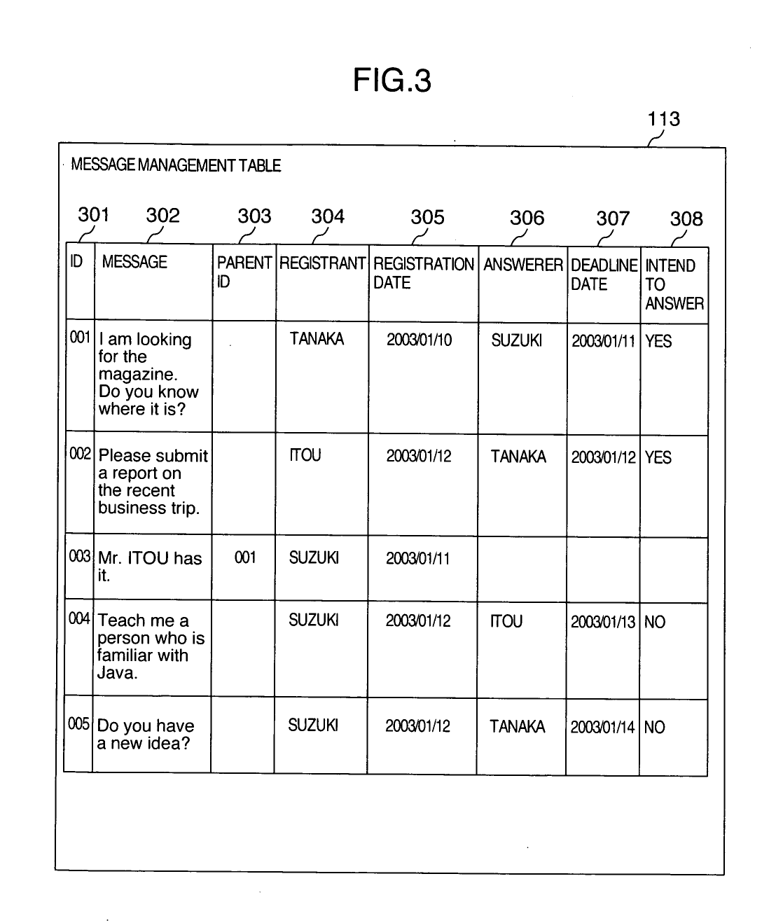

FIG. 2 is a diagram showing the processing of the message management unit 112. First, in Step 202, the message management unit 112 accepts a message registration request from a user terminal. In Step 203, the message management unit 112 references the message management table 113 and stores an ID (a new ID) generated by adding 1 to the ID of a message having the largest ID among the messages stored in the message management table 113 (The maximum ID in the message management table 113 shown in FIG. 3 is 005. When a new message registration request is received in this state, an ID 006 generated by adding 1 to 005 is stored). In Step 204, the message management unit 112 allocates an area, where information requested to be registered in the message management table 113 is to be stored, as a new record area and registers the new ID, stored in Step 203, in that area.

In Step 205, the message management unit 112 registers new information (message contents, registrant, registration date, answerer specified by registrant, answer deadline, etc.), accepted from the user terminal, in the message management table.

FIG. 3 is a diagram showing the detail of the message management table. The message management table 113 has the following columns: ID 301, Message 302, Parent ID 303, Registrant 304, Registration date 305, Answerer 306, Deadline date 307, and Intend to answer (indicates whether the specified answerer will answer) 308. When the message is an answer to a question, the Parent ID column 303 contains the ID indicating the question message. For example, message 003 is an answer to message 001, and message 005 is an answer (or a response) to message 004.

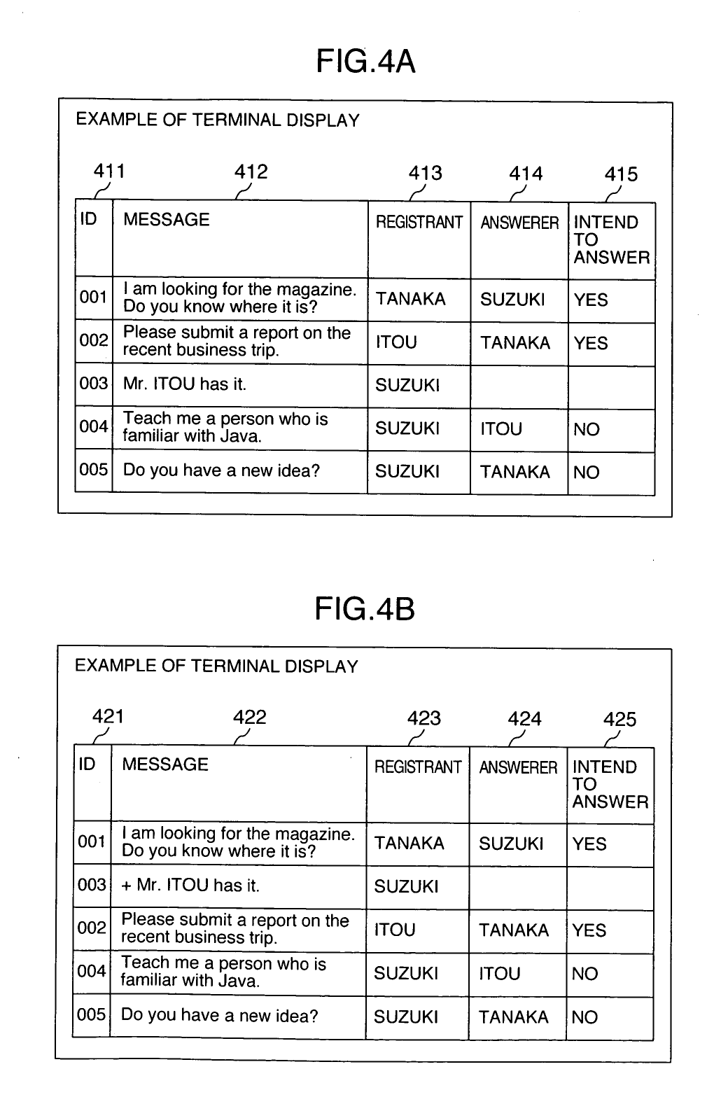

FIG. 4A and FIG. 4B are diagrams showing examples of display views displayed on the user terminal. FIG. 4A is a diagram showing an example in which messages are displayed in the order in which they were registered, and FIG. 4B is a diagram showing parent messages and answer messages to the parent messages that are displayed in succession.

In FIG. 4A and FIG. 4B, numerals 411 and 421 denote an ID, numerals 412 and 422 denote a message, numerals 413 and 423 denote a registrant, numerals 414 and 424 denote an answerer, and numerals 415 and 425 denote whether the answerer intends to answer.

Because the answerers are displayed with the messages 412 and 422 as shown in those figures, who should answer a message is easy to understand.

The messages, though displayed in order of message IDs in FIG. 4A, need not always be displayed in order of IDs. In FIG. 4B, the parent messages and the corresponding answer messages to those parent messages are displayed in succession in an easy-to-view format. In the example of this display, the symbol “+” added to the start of an answer message indicates that the message is an answer message.

Although a part of information (ID, message, registrant, and answerer) stored in the message management table 113 is displayed in the display examples shown in FIG. 4A and FIG. 4B, all information may also be displayed.

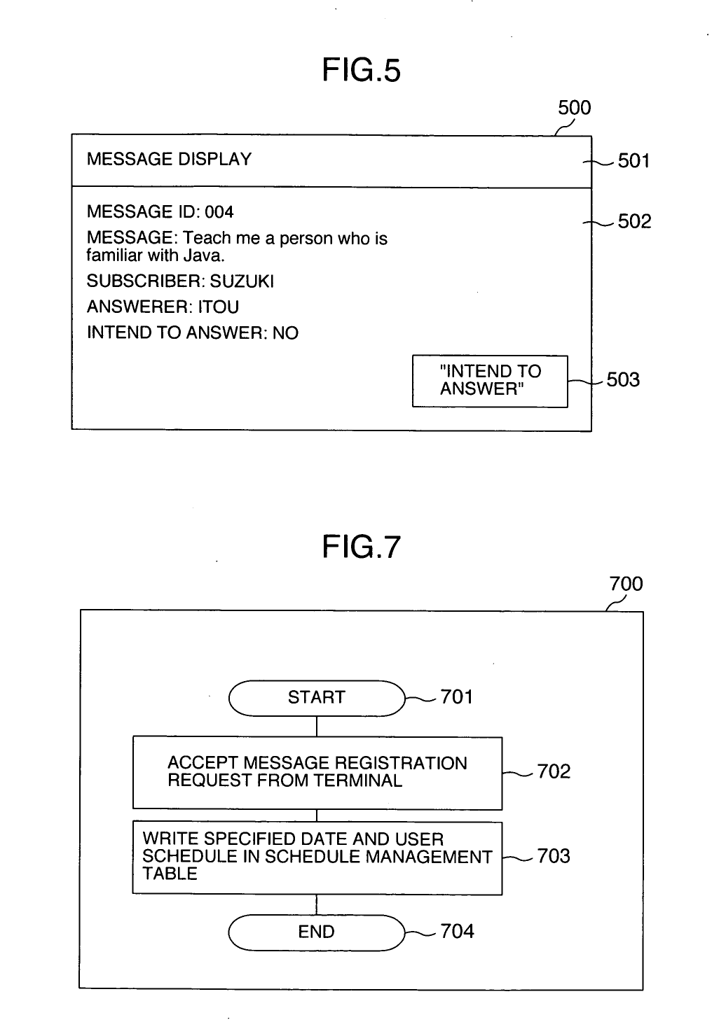

FIG. 5 is a diagram showing an example of the message display view displayed on a user terminal. This view is displayed, for example, when the user specified as the answerer selects the message shown in FIG. 4A “Teach me a person who is familiar with Java (trademark)” with a pointing device such as a mouse.

A message display view 500 is composed of a title area 501, a message display area 502, and an “Intend to answer” button 503. When the user specified as the answerer presses the “Intend to answer” button 503, this information is notified from the user terminal 100 to the message management unit 112 via the communication unit 102, the network 130, and the communication unit 111. In response to this notification, the message management unit 112 changes the value of the Intend to answer column 308 in the message management table 113 to “Yes”. If the value in this column is changed to “Yes”, the answerer's intention to answer the question can be displayed clearly.

Referring to the display example shown in FIG. 4B, the user SUZUKI specified as the answerer of message 001 has an intention to answer message 001 and, actually, the user SUZUKI registers the answer as message 003. The user TANAKA specified as the answerer of message 002 has an intention to answer the question but does not yet give an answer. The table also shows that the answerers have no intention to answer message 004 and message 005.

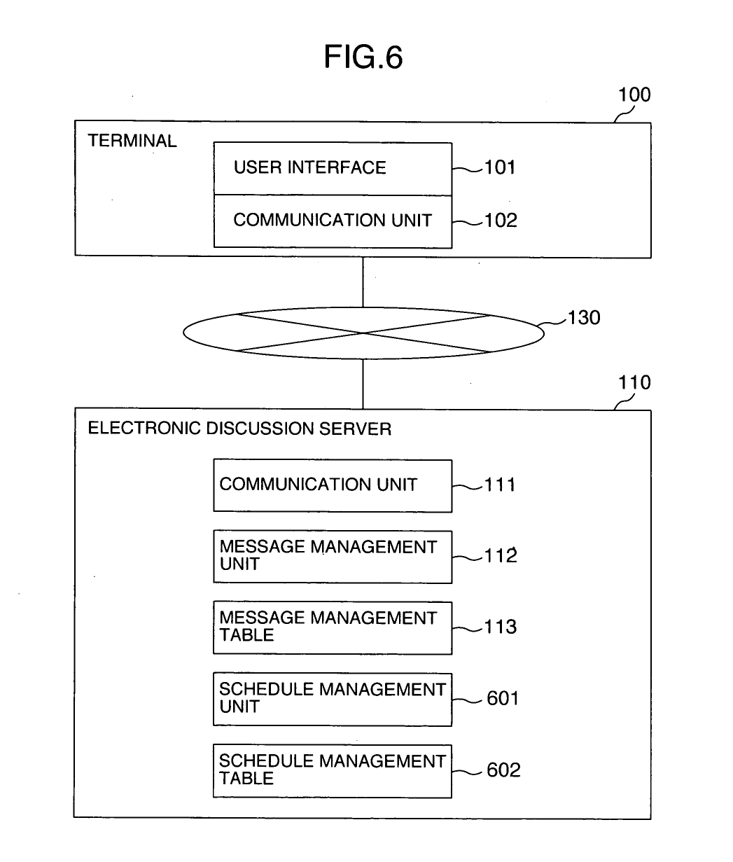

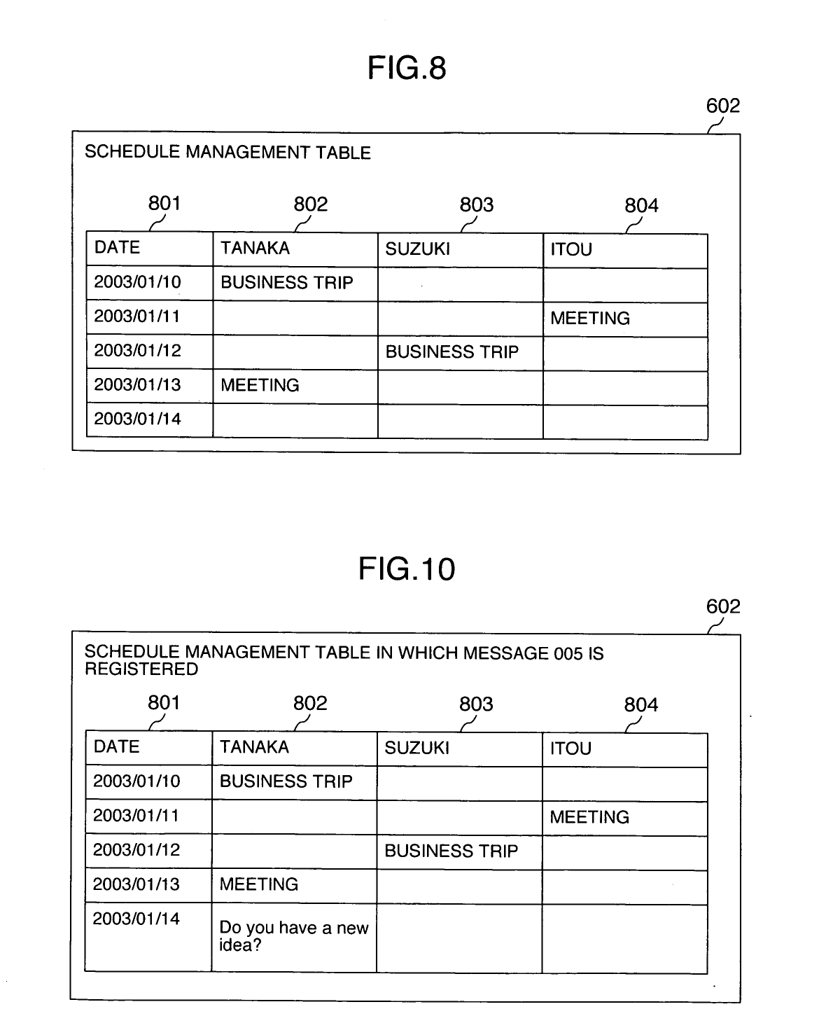

FIG. 6 is a diagram showing a second embodiment. Referring to FIG. 6, numeral 601 indicates a schedule management unit that manages the schedule of users based on the contents of a schedule management table, and numeral 602 indicates a schedule management table (see FIG. 8) in which the schedule of each user is stored. Numeral 112 indicates a message management unit. As will be described later, the message management unit 112 accepts information such as a message sent from a user terminal with an answerer specified, an answer to the message, or an answer deadline and stores the accepted information in the message management table. In the figure, the same reference numerals are used to denote the same elements in FIG. 1 and further description of that element will be omitted.

FIG. 7 is a diagram showing the processing of the schedule management unit 601. First, in Step 702, the schedule management unit 601 accepts a request to register a message, which includes schedule information on a user and the schedule period, from a user terminal. In Step 703, the schedule management unit 601 registers the accepted user schedule information and schedule periods in the schedule management table 602 for each user.

FIG. 8 is a diagram showing the detail of the schedule management table 602. The schedule management table 602 has the following columns: Date (deadline) 801 and schedules for the users (Schedule 802 of TANAKA, Schedule 803 of SUZUKI, and Schedule 804 of ITOU). The example shown in FIG. 8 indicates that TANAKA has a business trip schedule on 2003, Jan. 10, ITOU has a meeting schedule on 2003, Jan. 11, SUZUKI has a business trip schedule on 2003, Jan. 12, and TANAKA has a meeting schedule on 2003, Jan. 13.

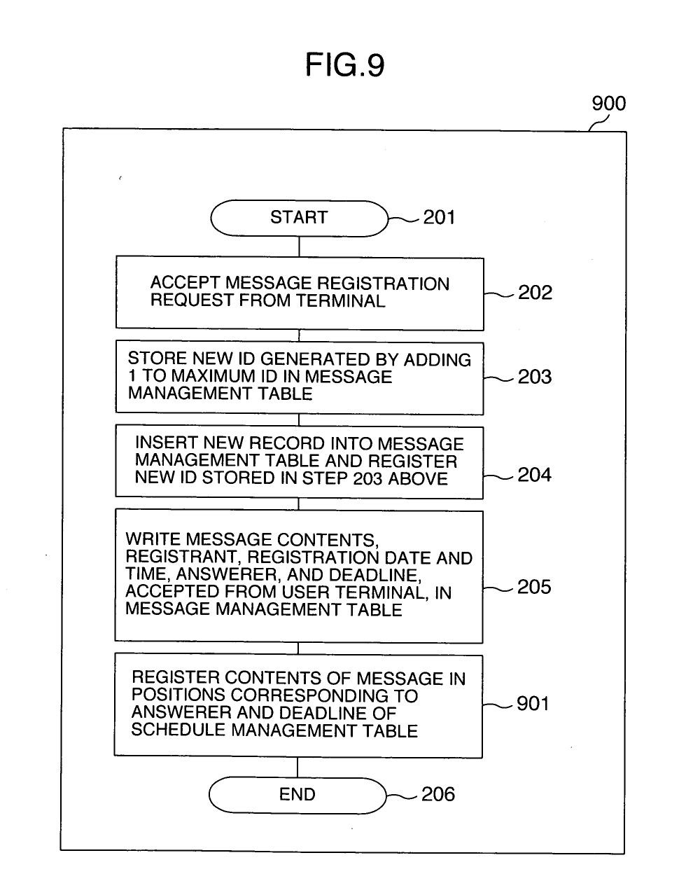

FIG. 9 is a diagram showing the processing of the message management unit 112. Because the processing in Steps 201-205 is the same as that in Steps 201-205 in FIG. 2, the detailed description is omitted. In Step 901, the message management unit 112 stores the contents of an accepted message in a position specified by the User (answerer) column and the Date (deadline) column of the schedule management table 602.

For example, when message 005 shown in FIG. 3 is registered in the schedule management table shown in FIG. 8, the answerer is TANAKA, the deadline is 2003, Jan. 14, and the contents of the message are “Do you have a new idea?”

FIG. 10 is a diagram showing the contents of the schedule management table 602 in which message 005 described above is registered. As shown in the figure, the message “Do you have a new idea?” is registered in the column TANAKA in the 2003, Jan. 14 row of the schedule management table 602. Although the contents of a message are registered in this example, the message ID may also be registered instead. In addition, the character string “answer deadline” indicating the deadline may also be registered. In this way, the answerer of a message can manage the answer deadlines as his/her schedule. A terminal user can reference this schedule management table to manage two types of schedules: one is a usual schedule registered by the terminal user and the other is a schedule as an answerer when the terminal user is specified as an answerer.

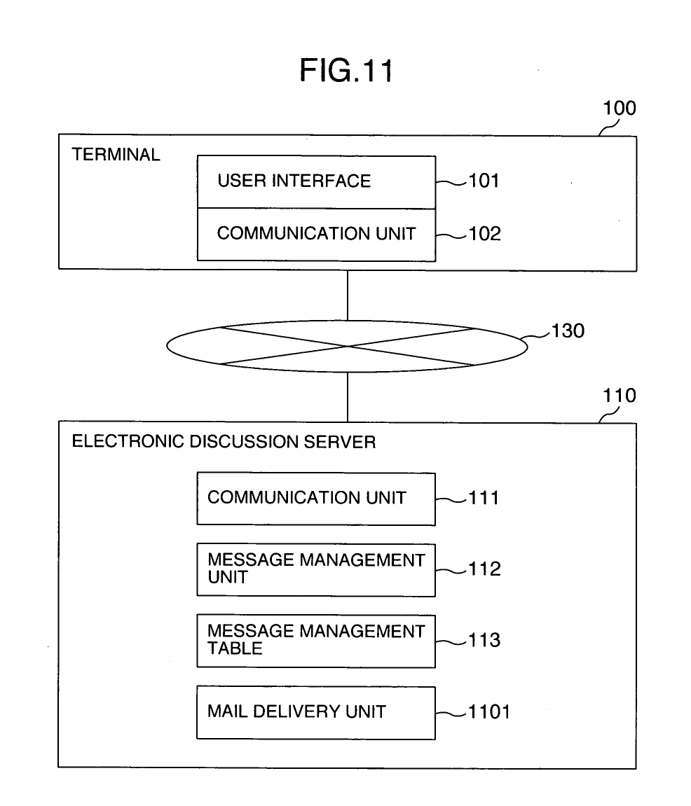

FIG. 11 is a diagram showing a third embodiment. Referring to FIG. 11, numeral 1101 denotes a mail delivery unit that sends a mail to an answerer for confirming if the answerer has an intention to answer or for notifying information on the answer deadline. In the figure, the same reference numerals are used to denote the same elements in FIG. 1 and further description of that element will be omitted.

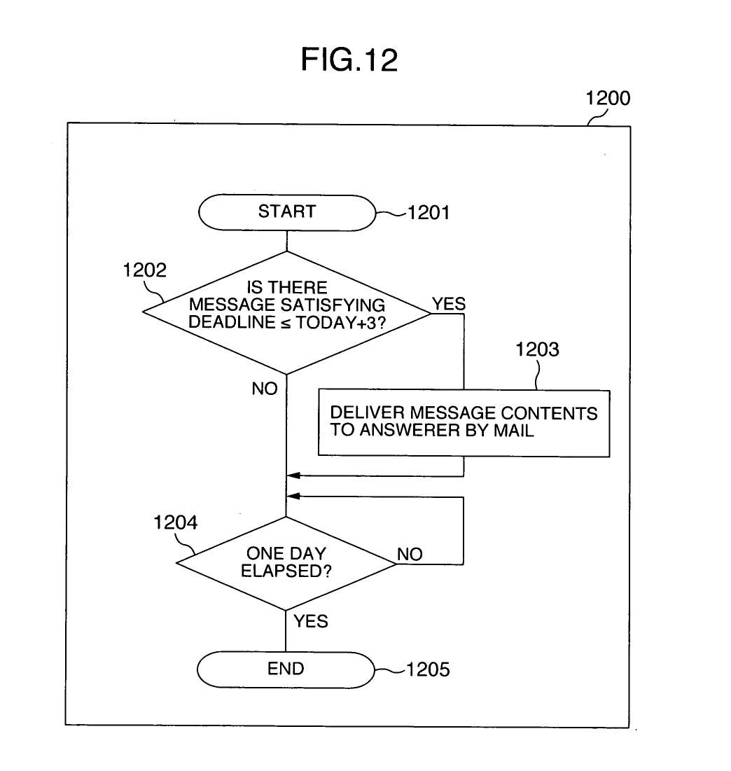

FIG. 12 is a diagram showing the processing of the mail delivery unit 1101. In Step 1202, the mail delivery unit 1101 checks if there is a message whose deadline stored in the message management table (or date in the schedule management table) is ≦(today's date+3 days) and if “Yes” is stored in the “Intend to answer” column. If there is such a message, control is passed to Step 1203. In Step 1203, the mail delivery unit 1101 sends the contents of the message to the answerer by mail. In Step 1204, the mail delivery unit 1101 checks if one day has elapsed and, if not, repeats Step 1204. If one day has elapsed, control is passed to Step 1202 to repeat the processing described above. Note that “today's date+1 day” indicates tomorrow. In this case, if there is a message whose deadline is within 3 days or the deadline is passed, the mail can be sent to the answerer once a day.

This mail notifies an answerer that the answerer is specified as an answerer and that the deadline approaches or is passed. The mail, though sent once a day in the example above, may also be sent once a week or twice a day. It is also possible to specify that the mail be sent at an interval of several hours. Although there is only one terminal in the embodiments described above, a plurality of terminals may also be used. Although described with the electronic discussion system as an example, the embodiments are also applicable to an electronic bulletin board system or a chat system.

As described above, the system and the method in the embodiments allow the user to check if an answerer intends to answer a question and, if the answerer intends to answer, notify the answerer that the deadline approaches or is passed. This allows an answer to a message to be obtained more reliably.

It should be further understood by those skilled in the art that although the foregoing description has been made on embodiments of the invention, the invention is not limited thereto and various changes and modifications may be made without departing from the spirit of the invention and the scope of the appended claims.

1. An electronic discussion system comprising:
a message management unit that accepts a message and an answer to the message from a plurality of terminals, said message being an answerer-specifying message specifying at least an answerer; and
a message management table in which the accepted message and the answer to the message are managed in a browsable manner,
wherein said message management unit further accepts a signal, which indicates whether the answerer has an intention to answer the accepted answerer-specifying message, via a terminal operated by the answerer and registers the accepted signal in said message management table.

2. A message registration and browsing method comprising the steps of:
accepting a message from a plurality of terminals that can communicate with an electronic discussion server, said message being an answerer-specifying message specifying at least an answerer;
storing the accepted answerer-specifying message in a manner browsable from the terminals; and
accepting a signal, which indicates whether the answerer has an intention to answer the accepted answerer-specifying message, via a terminal operated by the answerer and storing the accepted signal.

3. The message registration and browsing method according to claim 2, further comprising the step of sending, by the electronic discussion server, a message to the terminal operated by the answerer, said message requesting a response indicating whether the answerer has an intention to answer the answerer-specifying message.

4. The message registration and browsing method according to claim 2, further comprising the step of:
displaying the answerer-specifying message and the answer to the message in succession on the terminal.

5. The message registration and browsing method according to claim 2,
wherein the electronic discussion server has a schedule management table in which a schedule of a terminal user received from the terminal is managed.

6. The message registration and browsing method according to claim 2, further comprising the step of sending, by the electronic discussion server, a message requesting an answer to the terminal operated by the answerer when the electronic discussion server has received a response indicating that the answerer will answer the answerer-specifying message.

7. The message registration and browsing method according to claim 6, further comprising the step of sending the message requesting an answer to the terminal operated by the answerer when an answer deadline is within a predetermined time or is passed.

8. An electronic discussion program comprising a program that causes a computer to perform functions as:
a step of accepting an answerer-specifying message that specifies at least an answerer, an answer to the message, and a response indicating whether the answerer has an intention to answer the answerer-specifying message from a plurality of terminals; and
a step of managing the accepted message, the answer to the message, and a signal indicating whether the answerer has the intention in a browsable manner.

9. The electronic discussion program according to claim 8, further comprising a program that functions as means for sending a message to a terminal operated by the answerer, said message requesting a response indicating whether the answerer has an intention to answer the answerer-specifying message.

10. The electronic discussion program according to claim 8, further comprising a program that functions as a step of displaying the answerer-specifying message and the answer to the message on a terminal in succession.
